(19) United States
(12) Patent Application Publication
(10) Pub. No.: US 2013/0062160 A1
(43) Pub. Date: Mar. 14, 2013

(54) ARTICLE TRAY AND HANDLING OF ARTICLES WITH THE TRAY

(71) Applicants: Jeffrey J. Steinbach, Eagle, WI (US); Robert G. Lyon, Bluffdale, UT (US); Paul K. Gines, Kaysville, UT (US); Michael G. Thomas, Layton, UT (US); Ardalan Noordeh, Pewaukee, WI (US); Michael Carr, Alexandria, KY (US); Gabriel E. Kahl, Florence, KY (US); Michael C. Anderson, Watertown, WI (US)

(72) Inventors: Jeffrey J. Steinbach, Eagle, WI (US); Robert G. Lyon, Bluffdale, UT (US); Paul K. Gines, Kaysville, UT (US); Michael G. Thomas, Layton, UT (US); Ardalan Noordeh, Pewaukee, WI (US); Michael Carr, Alexandria, KY (US); Gabriel E. Kahl, Florence, KY (US); Michael C. Anderson, Watertown, WI (US)

(21) Appl. No.: 13/232,329

(22) Filed: Sep. 14, 2011

(51) Int. Cl. B65G 47/52

(52) U.S. Cl. 198/370.03; 198/617

(57) ABSTRACT

An article-handling system and method of handling articles with article trays having a support surface and a plurality of generally parallel grooves in said support surface includes loading articles on trays with an article-traying subsystem and unloading articles from trays with an article-detraying subsystem. The article-traying subsystem has a tray conveyor and a loading article conveyor. The loading article conveyor has a plurality of fingers adapted to fit within the grooves of a tray traveling on the tray conveyor at the article conveyor. An article is transferred to the tray support surface with the loading article conveyor. The article-detraying subsystem has a trayed article conveyor and an unloading article conveyor. The unloading article conveyor has a plurality of fingers adapted to fit within the grooves of the tray of a trayed article traveling on the trayed article conveyor at the unloading article conveyor. An article is removed from the tray support surface with the unloading article conveyor.

### BACKGROUND OF THE INVENTION

The present invention is directed to a material-handling system and method and, in particular, to a system and method that handles articles on trays and the trays used in such system. The invention has application to a variety of industries, including, but not limited to, the alcoholic and non-alcoholic beverage industry.

Certain articles may be difficult to handle because they are of a variety of shapes and sizes, have irregular or soft bottoms, or the like. One way to handle such articles is to position the articles on trays or totes and handle the trays or totes which are typically uniform in configuration. In order to do so, it is necessary to position the articles on trays, handle the trayed articles and remove the articles from the trays.

### SUMMARY OF THE INVENTION

The present invention provides an article tray and tray-handling system and method that allow articles of various sizes and configurations to be securely and efficiently handled.

An article-handling system and method of handling articles with article trays having a support surface and a plurality of generally parallel grooves in said support surface, according to an aspect of the invention, includes loading articles on trays with an article-traying subsystem and unloading articles from trays with an article-detraying subsystem. The article-traying subsystem has a tray conveyor and a loading article conveyor. The loading article conveyor has a plurality of fingers adapted to fit within the grooves of a tray traveling on the tray conveyor at the article conveyor. An article is transferred to the tray support surface with the loading article conveyor. The article-detraying subsystem has a trayed article conveyor and an unloading article conveyor. The unloading article conveyor has a plurality of fingers adapted to fit within the grooves of the tray of a trayed article traveling on the trayed article conveyor at the unloading article conveyor. An article is removed from the tray support surface with the unloading article conveyor.

The loading article conveyor may be at an acute angle to the tray conveyor. The tray conveyor may be more horizontal than the loading conveyor. The unloading article conveyor may be at an acute angle to the trayed article conveyor. The unloading article conveyor may be more horizontal than the trayed article conveyor. The loading article conveyor may include a plurality of powered conveyors, each at one of the fingers in order to propel an article toward the tray support surface with the powered conveyors. The powered conveyors may each be a travelling belt. The unloading article conveyor may include a plurality of powered conveyors, each at one of the fingers. An article is propelled away from the support surface with the powered conveyors. The powered conveyors may each be a travelling belt.

The article-handling system may further include an article storage subsystem to store trayed articles with the storage subsystem. The article storage subsystem may include a plurality of storage locations and a tray transfer mechanism to insert a trayed article to one of the storage locations and to extract a trayed article from one of the storage locations. The storage locations may be defined by vertically arranged rows of a rack. The tray transfer mechanism may be vertically along a vertically extending mast. Alternatively, the tray transfer mechanism may be positioned at a carriage and moved horizontally along at least one of the rows. The transfer mechanism may include a tray mover and a base supporting the tray mover. The base may be moved toward a storage location prior to inserting or extracting a trayed article and positioned away from the storage location while transporting the trayed article between the storage location and another location.

The tray transfer mechanism may include one or more tray-engaging extensions and a propulsion system. The propulsion system moves the extensions along a motion circuit to engage and move a trayed article. At least two tray-engaging extensions may be spaced apart in the direction of motion of the propulsion system in order to engage a trayed article with different extensions when engaging the trayed article from the right than from the left.

An article tray, according to an aspect of the invention, has a body which defines an article support surface that is of a size that is at least as large as the largest article to be handled, a pair of end walls, a pair of side walls and a plurality of generally parallel grooves formed below the support surface and extending through the side walls of the body.

The body may have a bottom surface that is formed from a separate member that is joined to the rest of body. A plurality of pockets may be defined in the bottom surface for engagement by a tray transfer mechanism in order to transfer trays bearing articles into and out of storage locations. The pockets may be formed in the area between the grooves inward of the side walls. The pockets may be formed on opposite sides of the bottom surface to allow the tray to be engaged from both sides. The body may be formed with honeycombs between the support surface and bottom surface in order to impart strength to the assembly. A pair of indents may be formed in the end walls in order to provide a place to engage each tray with an automatic tray stacker/destacker in order to assist in the handling of empty trays.

These and other objects, advantages and features of this invention will become apparent upon review of the following specification in conjunction with the drawings.

### BRIEF DESCRIPTION OF THE DRAWINGS

FIG. 1 is a perspective view of the top of a tray according to an embodiment of the invention;

FIG. 2 is a perspective view of the bottom of the tray in FIG. 1;

FIG. 3 is a side elevation of an article-detraying subsystem;

FIG. 4 is a top plan view of the article-detraying subsystem in FIG. 3;

FIG. 5 is a view taken along the lines V-V in FIG. 4;

FIG. 6 is a view taken along the lines VI-VI in FIG. 4;

FIG. 7 is a side elevation of an article-traying subsystem;

FIG. 8 is a top plan view of the tray in FIG. 1;

FIG. 9 is a side elevation of the tray in FIG. 8;

FIG. 10 is a sectional view taken along the lines X-X in FIG. 8;

FIG. 11 is a sectional view taken along the lines XI-XI in FIG. 8;

FIG. 12 is an end elevation of the tray in FIG. 8;

FIG. 13 is a sectional view taken along the lines XIII-XIII in FIG. 8;

FIG. 14 is a bottom plan view of the tray in FIG. 8 with a bottom plate removed to reveal internal details thereof;

FIG. 15 is a side elevation of an article storage subsystem;

FIG. 16 is an enlarged view of the area indication at XVI in FIG. 15;

FIG. 17 is an end elevation of the storage rack used with the article storage subsystem in FIG. 15;

FIG. 18 is an end elevation of a tray transfer mechanism;

FIG. 19 is sectional view taken along the lines XIX-XIX in FIG. 18; and

FIG. 20 is a sectional view taken along the lines XX-XX in FIG. 18.

### DESCRIPTION OF THE PREFERRED EMBODIMENT

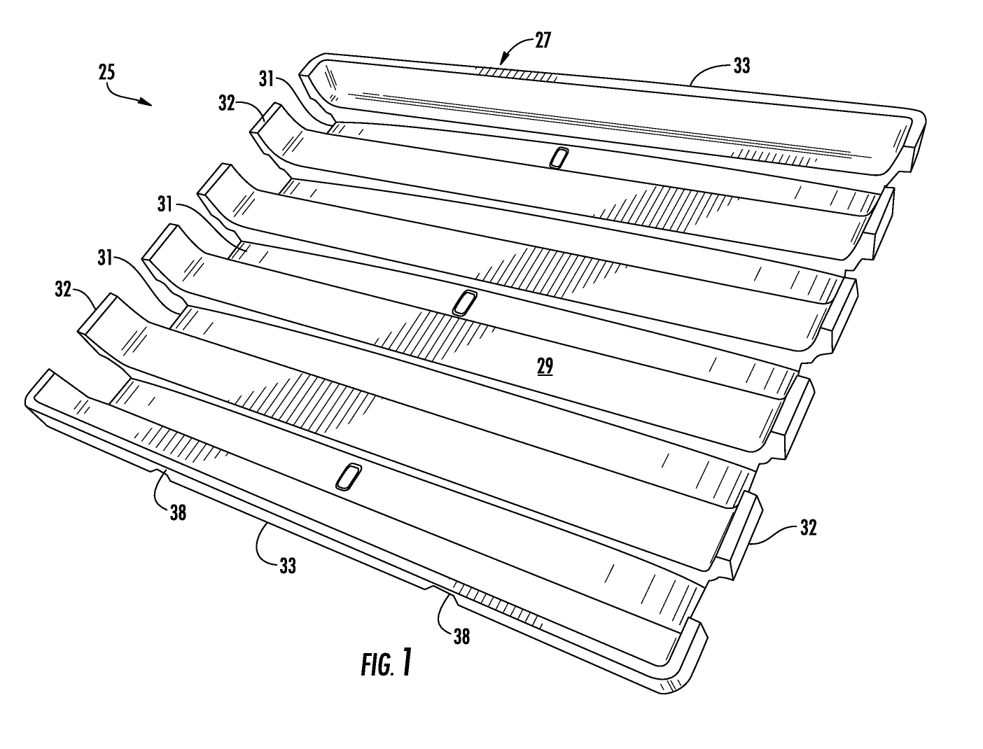

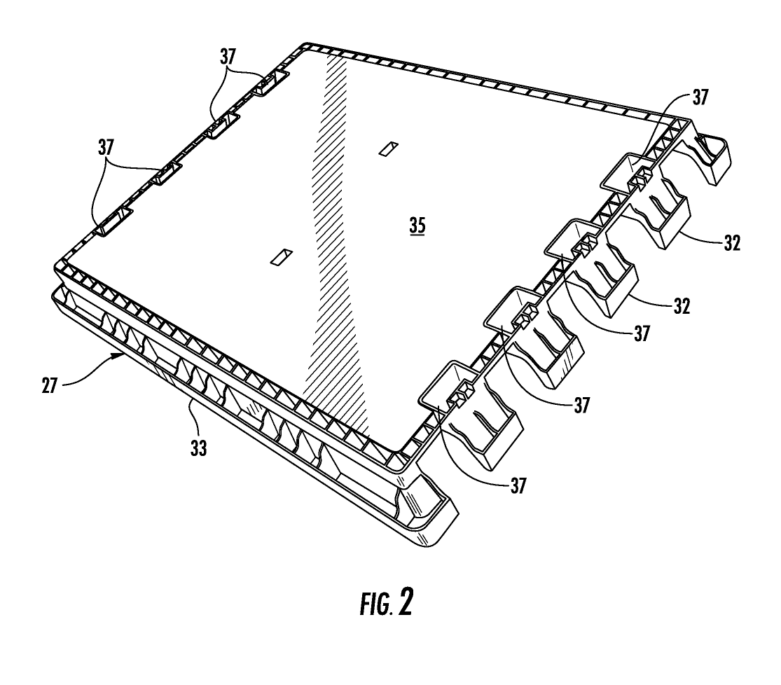

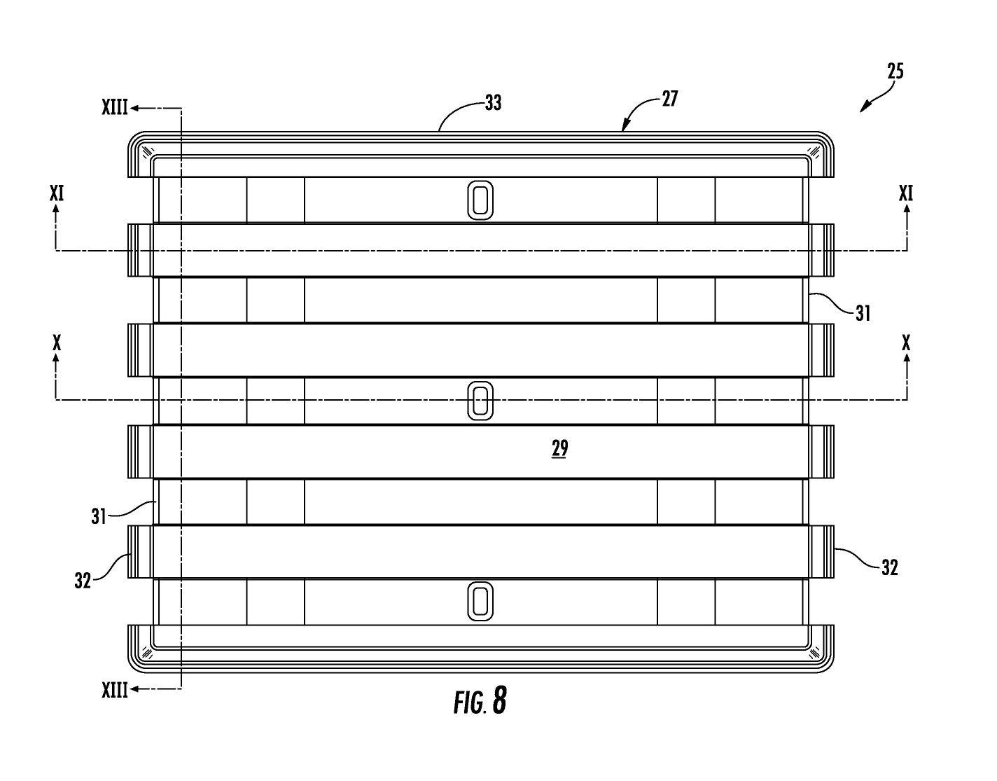

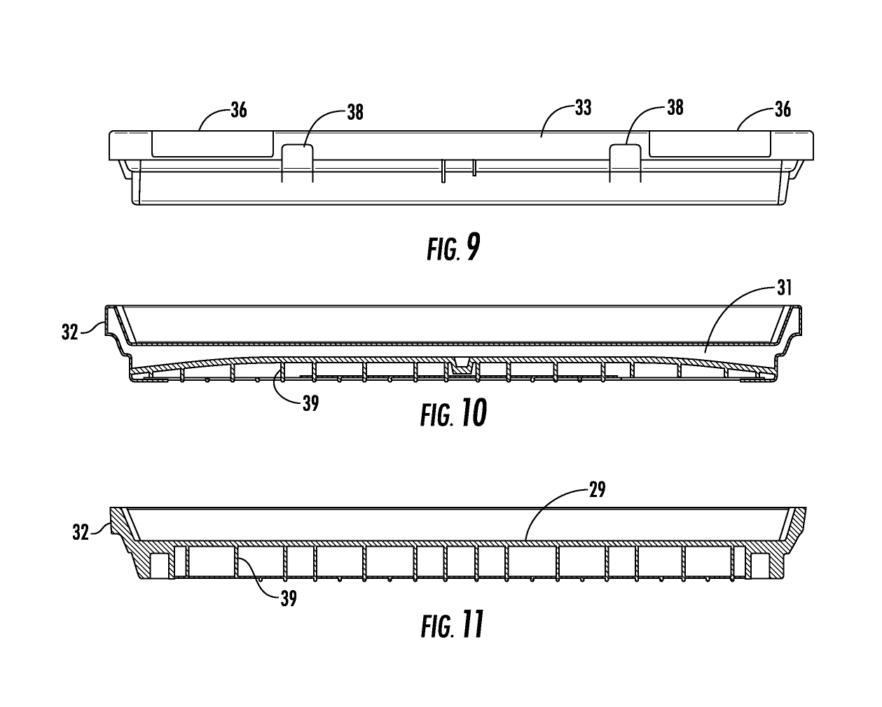

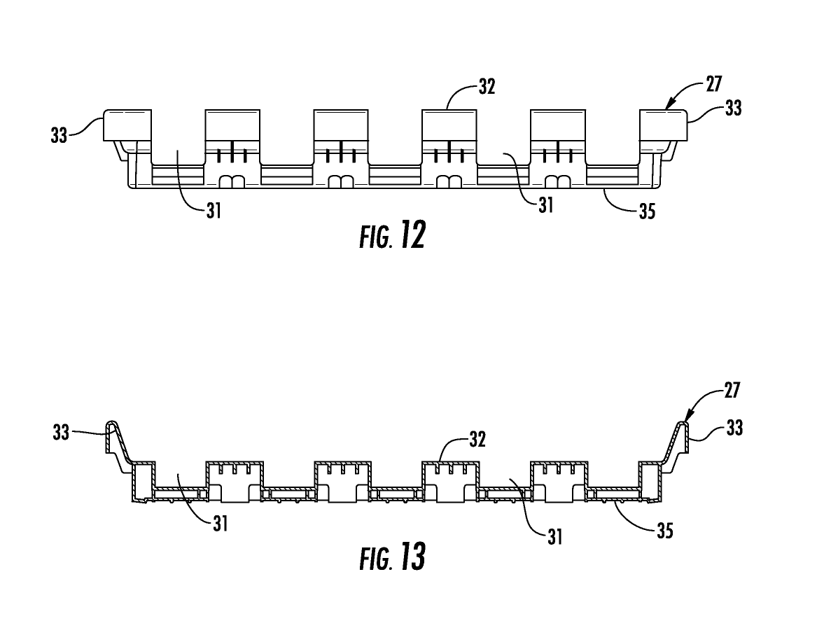

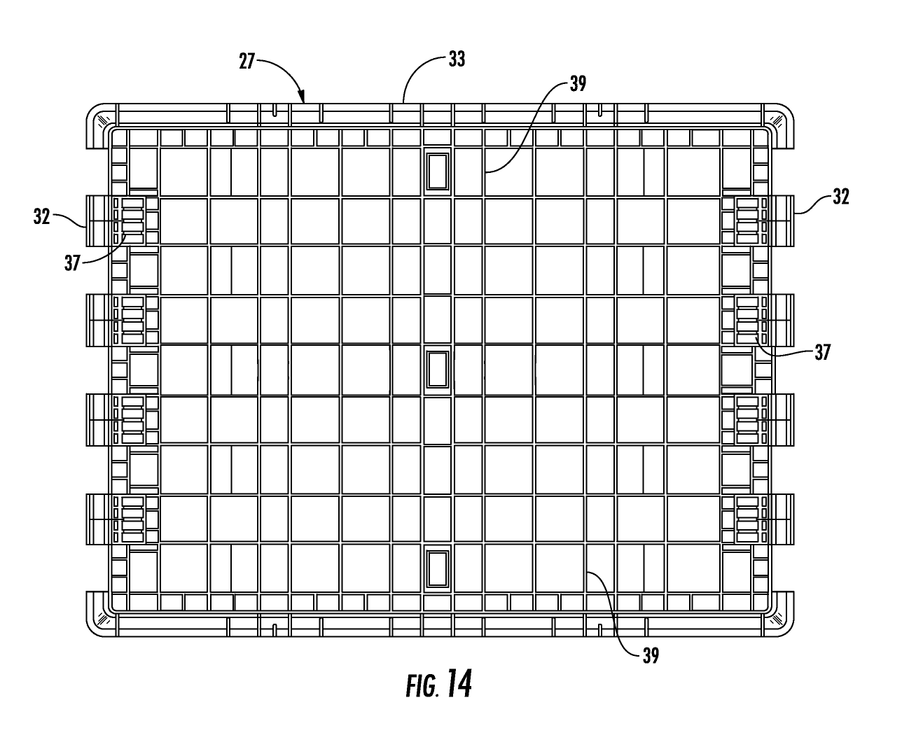

Referring now to the drawings and the illustrative embodiments depicted therein, an article-handling system 40 is used with trays 25, each having a body 27, which, in the illustrative embodiment, is molded in two pieces from any of a wide range of possible polymeric materials (FIGS. 1, 2 and 8-15). Each tray body 27 defines an article support surface 29 that is of a size that is at least as large as the largest article to be handled by system 40. Body 29 has a pair of end walls 33, and a plurality of generally parallel grooves 31 are formed below support surface 29 and extend through side walls 32. Body 27 has a bottom surface 35 that may be formed from a separate member that is joined to the rest of body 27, such as by sonic welding, adhesives, or the like.

A plurality of pockets 37 are defined in the bottom surface, which, as will be set forth in more detail below, are useful for engagement by a tray transfer mechanism in order to transfer trays bearing articles into and out of storage locations. In the illustrated embodiment, pockets 37 are formed in the area between grooves 31 inward of side walls 32. Pockets 37 are formed on opposite sides of bottom surface 35 to allow the tray to be engaged from both sides. Body 27 is formed with honeycombs 39 between the support surface and bottom surface in order to impart strength to the assembly. A pair of indents 38 may be formed in end walls 33 to provide a place to engage each tray with an automatic tray stacker/destacker (not shown) in order to assist in the handling of empty trays. One or more indented flat surfaces 36 may be provided to mount labels, such as bar code labels.

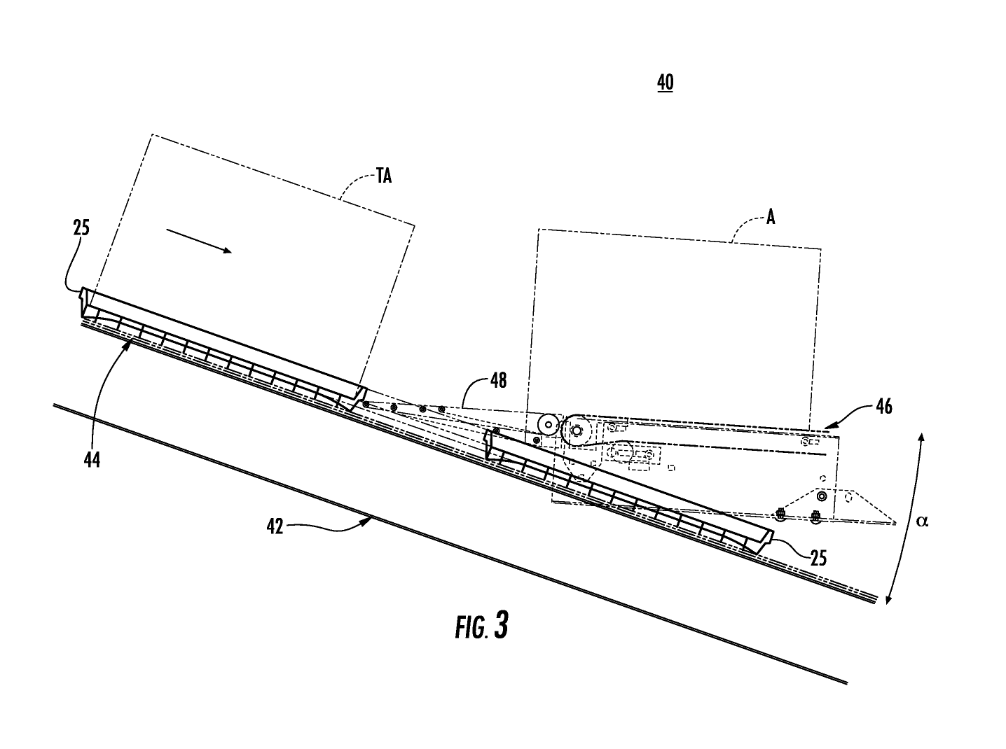

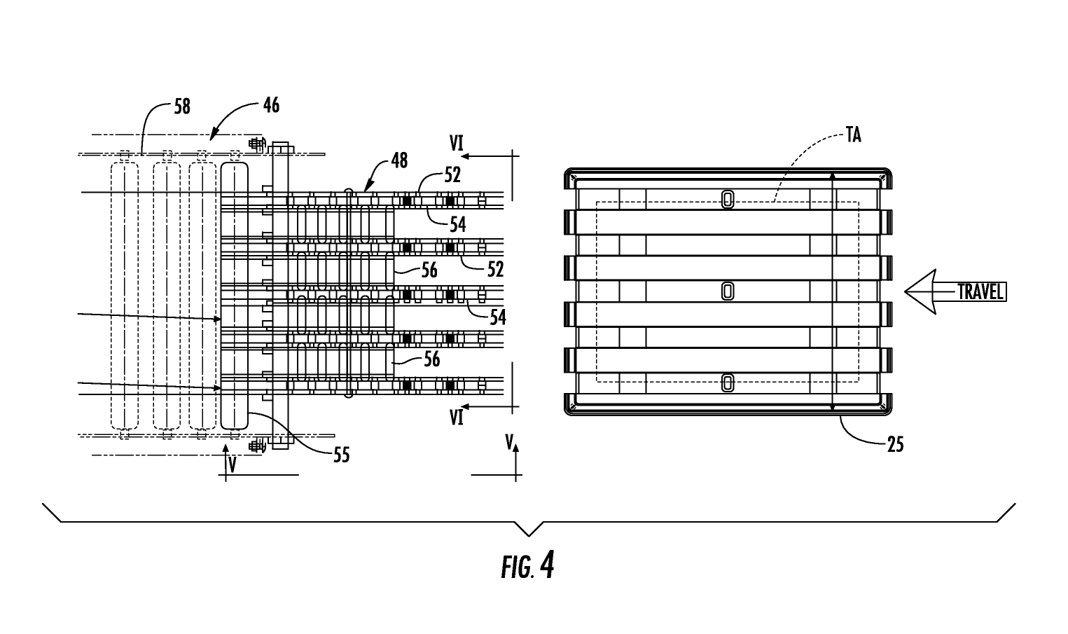

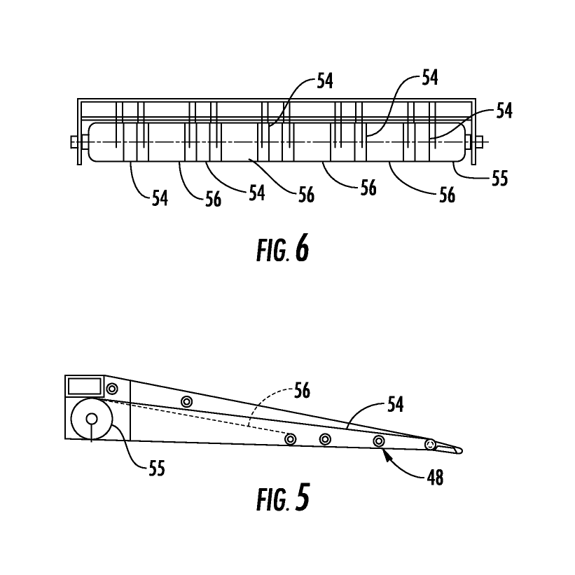

Article-handling system 40 includes an article-detraying subsystem 42 from removing trayed articles from trays (FIGS. 3-5). Article-detraying subsystem 42 has a trayed article conveyor 44 for conveying trayed articles to be detrayed and an unloading article conveyor 46 for unloading articles from trays. Unloading article conveyor 46 is made up of a plurality of fingers 48 that are configured to fit within grooves 31 of the tray of a trayed article “TA” traveling on trayed article conveyor 44 at unloading article conveyor 46 to remove an article “A” from tray support surface 29. Unloading article conveyor 46 is at an acute angle a with respect to trayed article conveyor 44. In the illustrated embodiment, angle a is at approximately 16 degrees, but could be at a variety of other acute angles. Also, in the illustrated embodiment, unloading article conveyor 46 is more horizontal than trayed article conveyor 44, which is at a decline in order to assist in the removal of the article from the tray.

Unloading article conveyor 46 is made up of a plurality of powered conveyors 52, each at one of said fingers 48 to propel an article away from support surface 29. In the illustrated embodiment, powered conveyors 52 are each a travelling belt 54. Various known drive sources may be used to drive belts 54, such as a driven roller 55. Such driven roller may be propelled from an internal motor or an external motor, both of which are well known in the art. Also, other types of powered conveyors may be used, such as powered rollers, or the like. A plurality of intermediate belts 56 may be provided in order to assist powered conveyors 52 to remove the articles from the trays. Intermediate belts 56 are between fingers 48 and terminate above the level of tray side walls 32. Unloading article conveyor 46 may further include a takeaway powered conveyor, such as a belt conveyor 58, in order to receive the detrayed articles from finger belts 54 and intermediate belts 56 and to pass the articles to a downstream conveyor (not shown).

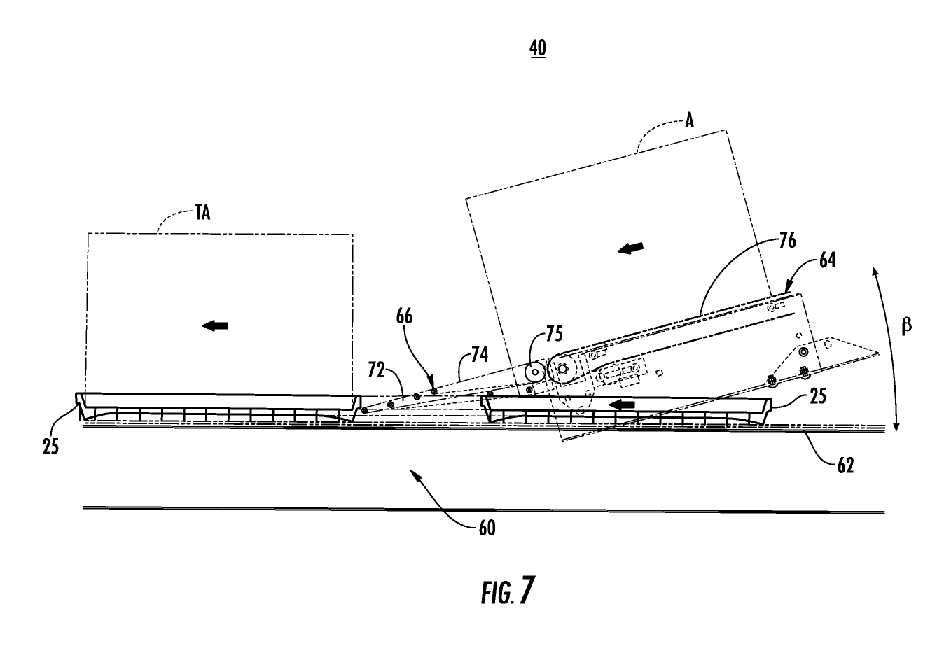

Article-handling system 40 may further include an article-traying subsystem 60 in order to place articles onto trays (FIG. 7). Article-traying subsystem 60 has a tray conveyor 62 and a loading article conveyor 64. Loading article conveyor has a plurality of fingers 66 that are configured to fit within the grooves 31 of a tray 25 traveling on tray conveyor 62 at loading article conveyor 64 in order to deposit an article at the tray support surface 29. As with fingers 48 of detraying subsystem 42, fingers 66 have a series of powered conveyors 70, such as finger belts 72 and intermediate belts 74, to feed the articles onto trays while fingers 66 are juxtaposed with grooves 31 in the trays. Finger belts 72 and intermediate belts 74 may be driven by a common driven roller 75. Loading article conveyor 64 may further include a feed belt 76 in order to feed an article “A” to fingers 66 in order to load the article onto a tray to become a trayed article “TA”. Feed belt 76 may be fed articles from an upstream conveyor (not shown). Loading article conveyor 64 may have a control system (not shown) in order to sense an approaching tray 25 on tray conveyor 62 using conventional sensors and control movement of loading article conveyor 64 in order to properly position the article on the tray.

Loading article conveyor 64 is at an acute angle β to tray conveyor 62. In the illustrated embodiment, β is approximately 16 degrees, but other angles may be used. Tray conveyor 62 is more horizontal than loading article conveyor 64 in order to use gravity to assist the loading of articles onto trays. Conveyors 46, 62 may be any type known in the art. In the illustrated embodiment, they are a perpetual merge belt marketed by Intralox Corporation.

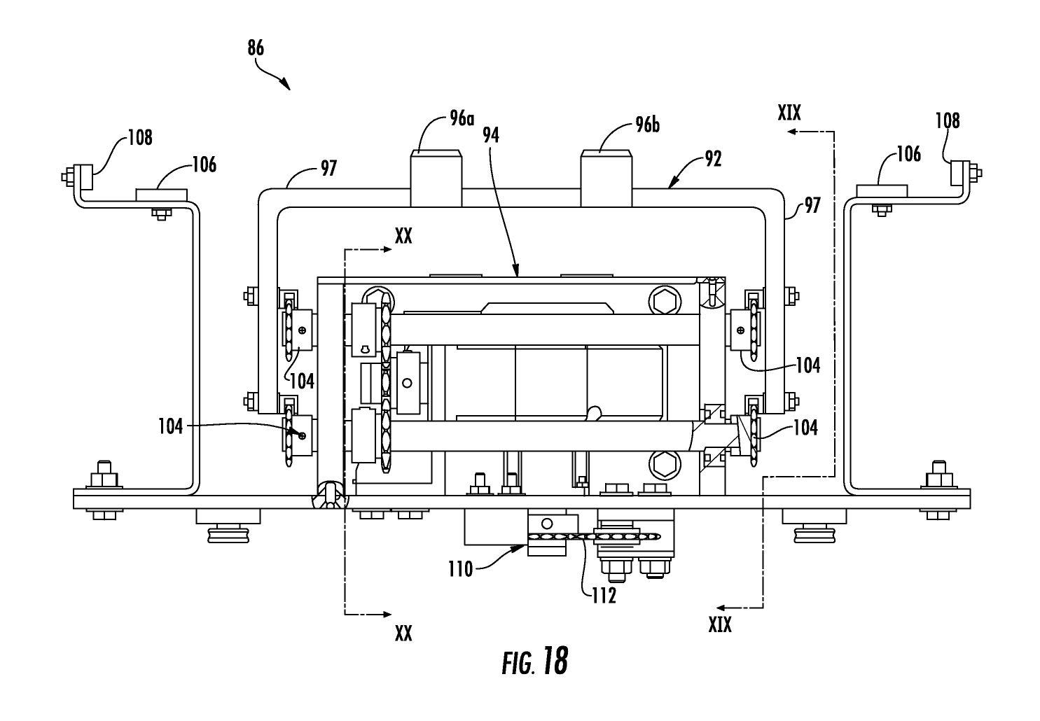

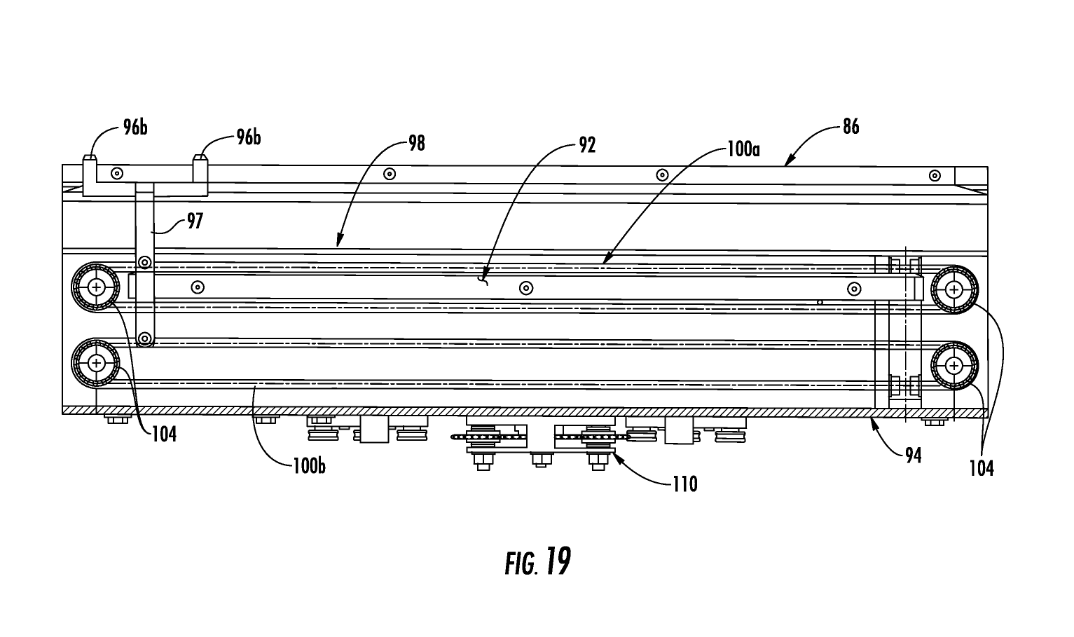

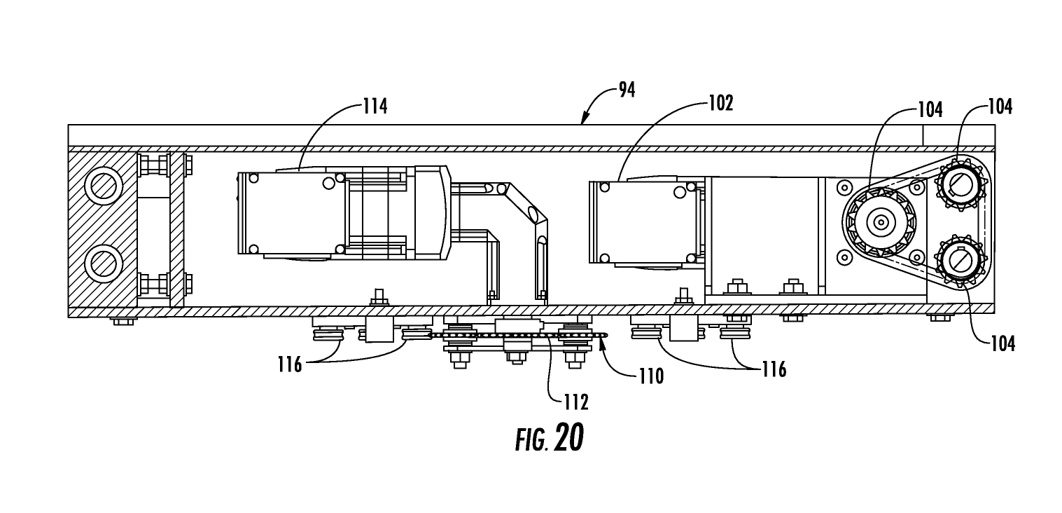

Article-handling system 40 may further include an article storage subsystem 80 that is adapted to store trayed articles TA (FIGS. 15-20). Article storage subsystem 80 includes a plurality of storage locations 82, such as defined by vertically arranged rows of a rack 84 and a tray transfer mechanism 86 for inserting a trayed article TA to one of storage locations 82 and to extract a trayed article TA from one of storage locations 82.

Tray transfer mechanism 86 may be vertically moveable along a vertically extending mast, schematically shown at 90, which may be stationary, or may be horizontally moveable along rack 84, as is known in the art as an automatic storage and retrieval system. Tray transfer mechanism 86 may be positioned at a carriage that travels horizontally along at least one of said rows of a three-dimensional warehouse, which is known in the art as a mini-loader or multi-shuttle system. Other applications will be apparent to the skilled artisan.

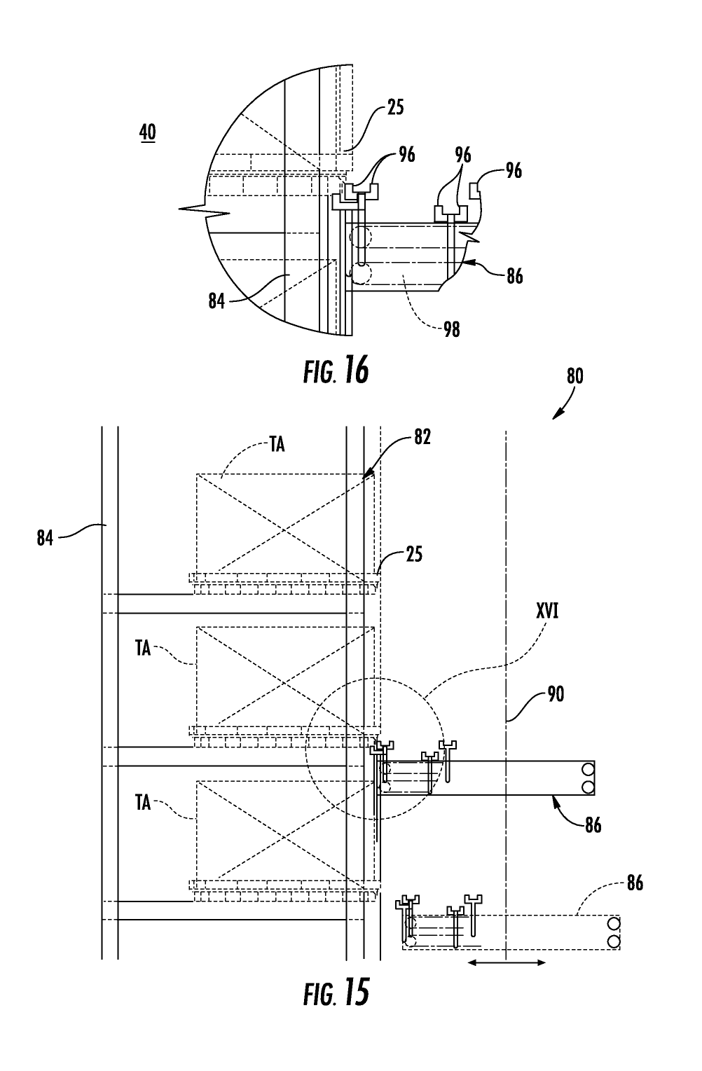

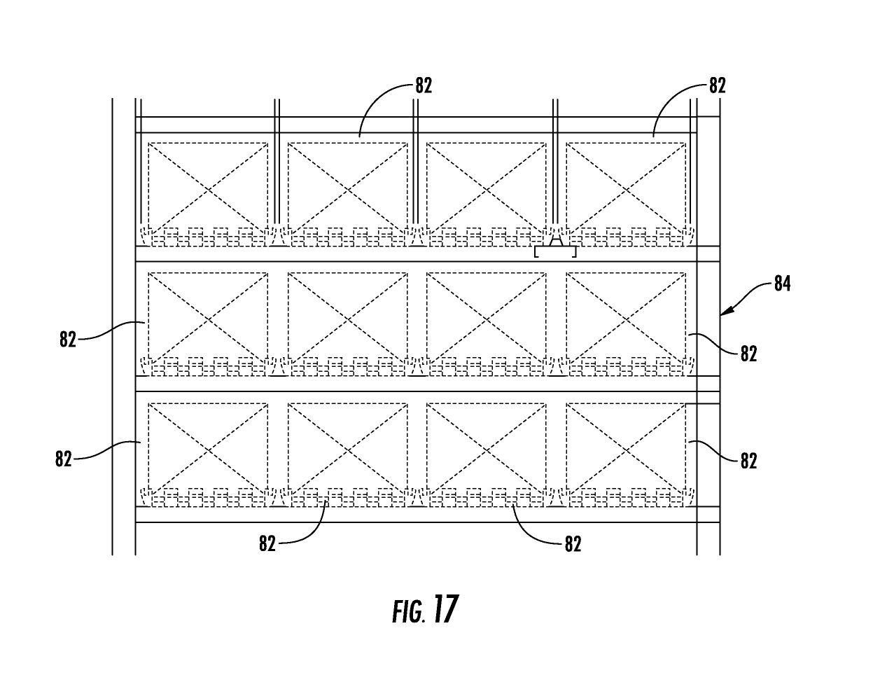

Tray transfer mechanism 86 includes a tray mover 92 and a base 94 that moveably supports the tray mover. Tray transfer mechanism 86 may be moveable toward a storage location 82 in order to insert or extract a trayed article, as seen in FIG. 16, and be moveable away from the storage location to transport the trayed article between the storage location and another location, as seen in phantom in FIG. 15. Tray mover 92, which moves with respect to base 94, includes at least one tray-engaging extension 96 and a propulsion system 98 to move the extension(s) along a motion circuit to thereby engage and move a trayed article. The at least one tray-engaging extension 96 may be two tray-engaging extensions 96a that are spaced apart in the direction of motion of propulsion system 98, as well as another two extensions 96b spaced from extensions 96a perpendicular to the direction of motion of propulsion system 98. In the illustrated embodiment, extensions 96a are mounted to a common support 97 to have the appearance of a football goal post. In a similar fashion, extensions 96b are also mounted to common support 97 to also have the appearance of a football goal post. Propulsion system 98 may be defined by two pairs of chains 100a, 100b, and one pair on each end of support 97. Chain pairs 100a, 100b are propelled in common by a motor 102 via rotation of a series of sprockets 104. By attaching the opposite ends of support 97 to each chain pair 100a, 100b, extensions 96 maintain an upright orientation as propulsion system 98 moves the extensions throughout its circuit motion. However, as propulsion system 98 moves extensions 96 in a circuit, the extensions are raised into a position in order to engage pockets 37 in trays followed by horizontal motion to transfer the tray into or out of a storage location 82. This horizontal motion is followed by a vertical lowering of extensions 96 in order to disengage the tray. By making propulsion system 98 bidirectional, tray transfer mechanism can move trays in opposite horizontal directions. Also, by providing pairs of extensions 96a, 96b on a common support attached to chains 100, one of the extension pairs 96a, 96b is best positioned to engage a tray from the left in the direction of propulsion system 98 and the other best positioned to engage a tray from the right, as will be apparent to the skilled artisan.

Tray transfer mechanism 86 may further include tray supports 106 to support opposite sides of the tray while it is being transferred and tray guides 108 to ensure the trays maintain a proper orientation in the event of only partial engagement between extensions 96a, 96b and pockets 37 in the tray.

Tray transfer mechanism 86 may be moved by a base propulsion system 110 attached primarily to base 94. Base propulsion system 110 includes a drive chain 112 driven by a motor 114 and attached to a stationary portion of the tray transfer mechanism. Base propulsion system 110 further includes a plurality of guide wheels 116 in order to guide the motion of the base.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. An article-handling system for use with article trays having a support surface and a plurality of generally parallel grooves in said support surface, said system comprising:
an article-traying subsystem, said article-traying subsystem having a tray conveyor and a loading article conveyor, said loading article conveyor having a plurality of fingers adapted to fit within the grooves of a tray traveling on said tray conveyor at said article conveyor to deposit an article at the tray support surface; and
an article detraying system, said article-traying subsystem having a trayed article conveyor and an unloading article conveyor, said unloading article conveyor having a plurality of fingers adapted to fit within the grooves of the tray of a traded article traveling on said trayed article conveyor at said unloading article conveyor to remove an article from the tray support surface.

2. The article-handling system as claimed in claim 1 wherein said loading article conveyor is at an acute angle to said tray conveyor.

3. The article-handling system as claimed in claim 2 wherein said tray conveyor is more horizontal than said loading conveyor.

4. The article-handling system as claimed in claim 1 wherein said unloading article conveyor is at an acute angle to said trayed article conveyor.

5. The article-handling system as claimed in claim 4 wherein said unloading article conveyor is more horizontal than said trayed article conveyor.

6. The article-handling system as claimed in claim 1 wherein said loading article conveyor comprises a plurality of powered conveyors, each at one of said fingers to propel an article toward the tray support surface.

7. The article-handling system as claimed in claim 6 wherein said powered conveyors each comprise a travelling belt.

8. The article-handling system as claimed in claim 1 wherein said unloading article conveyor comprises a plurality of powered conveyors, each at one of said fingers to propel an article away from the support surface.

9. The article-handling system as claimed in claim 8 wherein said powered conveyors each comprise a travelling belt.

10. The article-handling system as claimed in claim 1 including an article storage subsystem that is adapted to store trayed articles.

11. The article-handling system as claimed in claim 10 wherein said article storage subsystem comprises a plurality of storage locations and a tray transfer mechanism that is adapted to insert a trayed article to one of said storage locations and to extract a trayed article from one of said storage locations.

12. The article-handling system as claimed in claim 11 wherein said storage locations are defined by vertically arranged rows of a rack.

13. The article-handling system as claimed in claim 12 wherein said tray transfer mechanism is vertically moveable along a vertically extending mast.

14. The article-handling system as claimed in claim 12 wherein said tray transfer mechanism is positioned at a carriage that travels horizontally along at least one of said rows.

15. The article-handling system as claimed in claim 11 wherein said tray transfer mechanism includes a tray mover and a base supporting said tray mover, wherein said base is moveable toward a storage location in order to insert or extract a trayed article and is moveable away from the storage location to transport the trayed article between the storage location and another location.

16. The article-handling system as claimed in claim 15 wherein said tray transfer mechanism includes at least one tray-engaging extension and a propulsion system to move said at least one tray-engaging extension along a motion circuit to thereby engage and move a trayed article.

17. The article-handling system as claimed in claim 16 wherein said at least one tray-engaging extension comprises at least two tray-engaging extensions that are spaced apart in the direction of motion of said propulsion system in order to engage a trayed article with different ones of said at least two tray-engaging extensions when engaging the trayed article from the right than from the left.

18. A method of handling articles with article trays having a support surface and a plurality of generally parallel grooves in said support surface, said method comprising:
loading articles on trays with an article-traying subsystem, said article-traying subsystem having a tray conveyor and a loading article conveyor, said loading article conveyor having a plurality of fingers adapted to fit within the grooves of a tray traveling on said tray conveyor at said article conveyor and including depositing an article at the tray support surface with said loading article conveyor; and
unloading articles from trays with an article detraying system, said article-traying subsystem having a trayed article conveyor and an unloading article conveyor, said unloading article conveyor having a plurality of fingers adapted to fit within the grooves of the tray of a trayed article traveling on said trayed article conveyor at said unloading article conveyor and including removing an article from the tray support surface with said unloading article conveyor.

19. The method as claimed in claim 18 wherein said loading article conveyor is at an acute angle to said tray conveyor.

20. The method as claimed in claim 19 wherein said tray conveyor is more horizontal than said loading article conveyor.

21. The method as claimed in claim 18 wherein said unloading article conveyor is at an acute angle to said trayed article conveyor.

22. The method as claimed in claim 21 wherein said unloading article conveyor is more horizontal than said trayed article conveyor.

23. The method as claimed in claim 18 wherein said loading article conveyor comprises a plurality of powered conveyors, each at one of said fingers and including propelling an article toward the tray support surface with said powered conveyors.

24. The method as claimed in claim 23 wherein said powered conveyors each comprise a travelling belt.

25. The method as claimed in claim 18 wherein said unloading article conveyor comprises a plurality of powered conveyors, each at one of said fingers and including propelling an article away from the support surface with said powered conveyors.

26. The method as claimed in claim 25 wherein said powered conveyors each comprise a travelling belt.

27. The method as claimed in claim 18 including an article storage subsystem and including storing trayed articles with said storage subsystem.

28. The method as claimed in claim 27 wherein said article storage subsystem comprises an plurality of storage locations and a tray transfer mechanism that is adapted to insert a trayed article to one of said storage locations and to extract a trayed article from one of said storage locations.

29. The method as claimed in claim 28 wherein said storage locations are defined by vertically arranged rows of a rack.

30. The method as claimed in claim 29 including moving said tray transfer mechanism vertically along a vertically extending mast.

31. The method as claimed in claim 29 including positioning said tray transfer mechanism at a carriage and moving said carriage horizontally along at least one of said rows.

32. The method as claimed in claim 28 wherein said tray transfer mechanism includes a tray mover and a base supporting said tray mover and including moving said tray transfer mechanism toward a storage location prior to inserting or extracting a trayed article and positioning said base away from the storage location while transporting the trayed article between the storage location and another location.

33. The method as claimed in claim 32 wherein said tray mover includes at least one tray-engaging extension and a propulsion system and including moving said at least one tray-engaging extension along a motion circuit with said propulsion system to engage and move a trayed article.

34. The article-handling system as claimed in claim 33 wherein said at least one tray-engaging extension comprises at least two tray-engaging extensions that are spaced apart in the direction of motion of said propulsion system in order to engage a trayed article with different ones of said at least two tray-engaging extensions when engaging the trayed article from the right than from the left.
